(19) United States
(12) Patent Application Publication
(10) Pub. No.: US 2009/0319223 A1
(43) Pub. Date: Dec. 24, 2009

(54) Encoder with lifetime events memory

(75) Inventors: Josef Siraky, Donaueschingen (DE); Reinhold Mutschler, Villingen-Schwenningen (DE); Mark Eustache, Troy, OH (US)

Correspondence Address: THE NATH LAW GROUP, 112 South West Street, Alexandria, VA, 22314, US

(73) Assignee: SICK STEGMANN GmbH, Donaueschingen (DE)

(21) Appl. No.: 12/457,733

(22) Filed: Jun. 19, 2009

(30) Foreign Application Priority Data
Jun. 24, 2008 (EP) 08 011 410.1

(51) Int. Cl. G06F 15/00

(52) U.S. Cl. 702/150; 702/182

(57) ABSTRACT

A position measuring system features a position measuring device (1), an interface to transmit the position signals of the position measuring device (1) to an electronic control unit, a microcontroller (2) and a non-volatile memory (3), in which characteristic values of the position measuring system are stored, and from which said values can be read out via the interface. During the operation of the position measuring system the microcontroller (2) records state variables of the position measuring system or of a servo drive, respectively, and stores such variables in the memory (3).

The invention relates to a position measuring system in accordance with the characterizing clause of claim 1.

Position measuring systems are used to measure the rotatory or linear position of two objects movable against each other, and of parameters that depend on these positions, such as for example speed, acceleration, and the like. The position measuring system features a position measuring device that consists of a material measure—the latter being scanned optically, capacitatively, inductively, or in another way—, with position signals generated by the scanning being transmitted via an interface to an electronic control unit. Various embodiments of such position measuring devices are known prior art, with all such known position measuring devices being able to be employed in the position measuring system according to the invention. Combining the position measuring device with a motor as servo drive is a frequent use of such a device.

It is for example also known from DE 43 42 377 A1 to equip the position measuring system with a microcontroller or microprocessor and a memory. Characteristic values of the position measuring system can be stored in the memory and can be read from the memory, and transmitted via the interface to the control unit. The memory in this familiar position measuring system serves as a so-called “electronic type plate.” The characteristic values stored in the memory represent parameters that characterize the measuring system and that serve to adapt the measuring system to the control unit. In part, these characteristic parameters are stored inside the memory by the manufacturer of the measuring system and, in part, may also be stored by the user. Such parameters are, for example, details about the type of the position measuring device, about the data transmission formats, about the signal periods, about the position of reference marks, about zero point shifts, and about the type specification and the serial number of the measuring system. In general, these characteristic parameters are stored once before starting up the position measuring system, and may be retrieved, in each case, if the position measuring system is connected to a downstream electronic control unit, and if such system must be adapted.

The invention is based on the task to advance such a position measuring system such that additional information is available that expands the usefulness of the position measuring system.

This task according to the invention is solved by a position measuring system featuring the characteristics of claim 1.

Advantageous embodiments of the invention are listed in the subclaims.

The essential idea behind the invention is to also use the internal memory of the position measuring system to record state variables that are important for the function of the measuring system—or more general—of a servo drive using the measuring system during the measuring system's operation, and that can change during the operation, and to store such variables in the memory. This makes it possible to continuously record state variables essential for the operation of the measuring system or of the servo drive. On the one hand, recording the state variables may be used to monitor the measuring system's or the servo drive's operation, and to ascertain and identify potential errors and malfunctions. Recording the state variables may also be used to register the measuring system's period of operation and the operational demands, in particular mechanical demands of the measuring system and/or the servo drive during operation, in order to determine the service life of the measuring system or of the servo drive and/or the maintenance intervals.

Preferably, a clock is assigned to the position measuring system allowing recording of the state variables in real time. This clock may be integrated into the measuring system, e.g. into the microcontroller. It is also possible to use an external clock that preferably exists in the electronic control unit, so as to receive the real time of day from the control unit via the interface when the position measuring system is connected to the electronic control unit, or when the position measuring system is switched on.

The state variables recorded during the measuring system's operation and stored in the memory especially comprise operating values of the system. In this connection, values linked to the function of the position measuring device during operation are referred to as operating values. Such operating values are for example the voltage and/or current amplitude of the position signals, the speed and/or acceleration of the position measuring device, and the like. For such operating values that do not change or only change little during proper functioning of the measuring system it is advantageous to record and store the maxima of such operating values, in each case. During proper operation these maxima must range between predetermined tolerances.

It is practical in this connection to determine and store these maxima in presettable time intervals.

Values that have an influence on the service life or on the maintenance intervals represent additional operating values. Operating values that can refer to the entire servo drive are for example the period of operation, i.e. the total duty cycle of the measuring system, the number of reversals of the direction of movement of the position measuring device, and in the case of rotatory measuring devices, for example, the number of revolutions of such measuring device. Such operating values are continuously recorded and added and stored by the microcontroller.

Furthermore, the position measuring system can feature additional sensors that record important environmental influences for the operation and the functioning of the measuring system and/or the servo drive. In this case, the measured values of these sensors represent the state variables. Sensors that may be designed in a generally known manner include for example sensors for temperature, vibration, with the ability to measure intensity as well as frequency of the vibrations, and also the load affecting the servo drive. With respect to these additional measured values as well it is generally practical to determine and store the maxima of these measured values, with the possibility of determining and storing the respective maxima within presettable time intervals here as well.

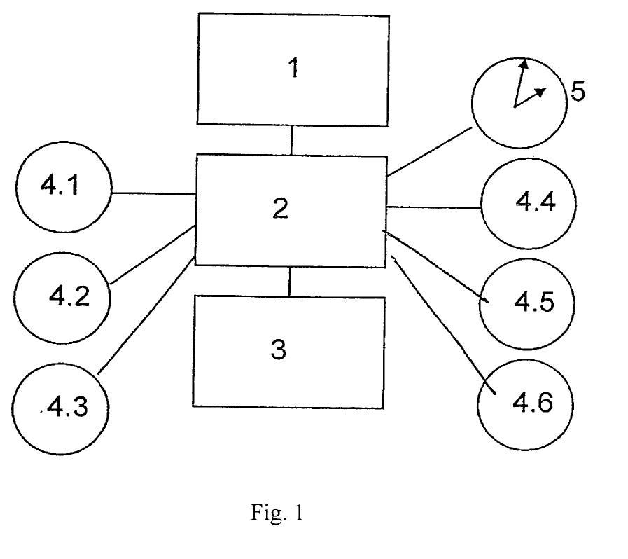

In the following the invention is described in detail based on an embodiment illustrated in the drawing, with the only FIG. 1 showing the assembly of the position measuring system in a schematic block diagram.

The position measuring system features a position measuring device 1 that can be designed in a generally known manner as a linear or rotatory measuring device, featuring a material measure that can be scanned optically, capacitatively, inductively, or in another way, and that can be analyzed incrementally or absolutely. The measuring device 1 is linked to a microcontroller or microcomputer 2. The measuring system further features a non-volatile memory 3, which is designed as EEPROM, for example. The memory 3 is integrated into the position measuring system. For this purpose, the memory 3 can for example be integrated into the microcontroller 2, or designed as a separate memory module.

The microcontroller 2 is connected to a clock 5, which indicates the real time. Said clock 5 may be integrated into the position measuring system with the microcontroller 2, or it may be an external clock 5 of an electronic control unit downstream from the position measuring system, for example of a servo drive. In the latter case, the real time indicated by the clock 5 is supplied to the microcontroller 2 via a non-exhibited interface, when the position measuring system is connected to the electronic control unit via said interface and switched on.

Further, sensors 4.1, 4.2, . . . 4.6 are connected to the microcontroller 2 measuring the environmental conditions of the position measuring system or of an entire servo drive, such as for example the temperature, vibrations, the descending force of a servo motor employing the position measuring system, or the like.

The microcontroller 2 can record a multitude of state variables and store them in the memory 3. The state variables stored in the memory 3 can be queried and read out by the non-exhibited generally known electronic control unit via the non-exhibited generally known interface.

For example, the microcontroller 2 can measure and store the period of operation, during which the position measuring system is switched on and in operation, in real time in accordance with the real time preset by the clock 5. Furthermore, the microcontroller 2 can count and store the number of reversals of the direction of movement of the position measuring device 1, and thus also of a servo drive. If the position measuring device 1 is designed as a rotatory measuring device, the microcontroller 2 can count the number of revolutions of the shaft of the position measuring device 1, and store them in the memory 3.

Moreover, the microcontroller 2 can record operating values of the measuring system, e.g. the voltage or current amplitude of the position signals of the position measuring device 1, speed and/or acceleration values that are recorded by the position measuring device 1, etc. Preferably, in each case the maximum values of these operating values are determined by the microcontroller 2 and stored in the memory 3. These maximum values can be determined and stored as maxima during the entire period of operation, or the respective maxima can be determined during time intervals preset and measured by means of the clock 5, so that the respective maxima are stored in the memory 3 within successive time intervals.

Finally, information about the environmental conditions of the position measuring system or of a servo motor connected to the position measuring system or the like can be recorded via the sensors 4.1 through 4.6 and stored in the memory 3 via the microcontroller 2. Here, too, it is practical for the purpose of monitoring the function and documentation to determine the maxima of the measured values recorded by the sensors 4.1 through 4.6 and store said maxima in the memory 3. In doing so, the maxima about the entire period of operation of the position measuring system can also be stored, or in each case the maxima in preset successive time intervals.

In the position measuring system according to the invention not only the parameters of the so-called electronic type plate characteristic for the position measuring system can be stored and queried, if required. Current state variables relating to the function of the measuring system or the servo drive, respectively, or the environmental conditions, can also be recorded and stored and/or registered during the position measuring system's operation. This makes it possible to monitor and document the function of the position measuring system or the servo drive, respectively, thereby improving reliability and error detection. Environmental conditions can also be recorded and, if required, assigned to the operating values pertaining to the function. Finally, the recorded and stored state variables can be used to determine and document the service life and operational reliability of the position measuring system or the servo drive, respectively, and, if need be, determine and indicate necessary maintenance dates.

1. Position measuring system with a position measuring device (1), featuring an interface to transmit the position signals of the position measuring device (1) to an electronic control unit, featuring a microcontroller (2) or microprocessor and a non-volatile memory (3), in which characteristic values of the position measuring system are stored, and from which these values can be read out via the interface, characterized in that the microcontroller (2) records state variables of said position measuring system and/or of a servo drive using said position measuring system during the position measuring system's operation, and stores such variables in the memory (3).

2. Position measuring system according to claim 1, characterized in that a clock (5) is assigned to the microcontroller, said clock making it possible to record state variables in real time.

3. Position measuring system according to claim 2, characterized in that the clock (5) is integrated into the position measuring system.

4. Position measuring system according to claim 2, characterized in that the clock (5) is externally integrated into the control unit, and said clock is connected to the position measuring system during operation.

5. Position measuring system according to claim 1, characterized in that the state variables comprise operating values of the position measuring system and/or the servo drive.

6. Position measuring system according to claim 5, characterized in that maxima of the operating values are determined and stored.

7. Position measuring system according to claim 6, characterized in that the maxima of the operating values are determined and stored in presettable time intervals.

8. Position measuring system according to claim 5, characterized in that the operating values comprise the voltage and/or the current of the position signals and/or the speed and/or the acceleration of the position measuring device (1).

9. Position measuring system according to claim 5, characterized in that the operating values comprise the period of operation and/or the number of reversals of the direction of movement of the position measuring device (1), and/or, in the case of rotatory position measuring devices (1), the number of revolutions of such position measuring device (1).

10. Position measuring system according to one of the claim 1, characterized in that the position measuring system and/or the servo drive features additional sensors (4.1, 4.2 . . . 4.6), and that the state variables are measured values of said sensors.

11. Position measuring system according to claim 10, characterized in that the maxima of the measured values of the sensors (4.1, 4.2 . . . 4.6) are determined and stored.

12. Position measuring system according to claim 11, characterized in that the maxima of the measured values are determined and stored within preset time intervals, in each case.

13. Position measuring system according to claim 10, characterized in that the sensors (4.1, 4.2 . . . 4.6) comprise sensors for temperature and/or for vibrations and/or for the mechanical demands of the position measuring device (2) and/or of the servo drive.
